(19) United States
(12) Patent Application Publication
(10) Pub. No.: US 2022/0260707 A1
(43) Pub. Date: Aug. 18, 2022

(54) SYSTEMS AND METHODS FOR DETERMINING OPERATIONAL PARAMETERS OF A SYNTHETIC APERTURE RADAR

(71) Applicant: URTHECAST CORP, Vancouver (CA)

(72) Inventors: Julie Nutini, Vancouver (CA); Jaklyn De Vos, Vancouver (CA); Peter Allen Fox, Burnaby (CA); Ives José de Albuquerque Macêdo, Jr., Vancouver (CA)

(21) Appl. No.: 17/624,806

(22) PCT Filed: Jul. 6, 2020
(86) PCT No.: PCT/US2020/040921

§ 371 Date: Jan. 4, 2022

Related U.S. Application Data
(60) Provisional application No. 62/870,917, filed on Jul. 5, 2019.

(51) Int. Cl. G01S 13/90

(52) U.S. Cl. CPC G01S 13/9056

(57) ABSTRACT

A method of determining feasible swaths of a synthetic aperture radar (SAR) includes determining a first plurality of swaths that are transmit-feasible and nadir-feasible, determining a second plurality of swaths of the first plurality of swaths that satisfy at least one hard constraint, the at least one hard constraint being an image quality constraint or a system constraint, and generating a graph of the second plurality of swaths. The method may include assigning each feasible swath of the second plurality of swaths to a node in a directed graph, and adding a directed edge in the directed graph when a pair of swaths of the second plurality of swaths satisfy one or more defined constraints. The method may include configuring the SAR to operate based at least in part on the generated graph of the second plurality of swaths. Operating the configured SAR may include obtaining SAR images.

### BACKGROUND

### Technical Field

The present application relates generally to synthetic aperture radar (SAR) and, more particularly, to efficient determination of operating parameters that meet one or more image quality constraints.

### Description of the Related Art

A synthetic aperture radar (SAR) is an imaging radar. The SAR exploits a relative motion of the radar and a target of interest to obtain high azimuthal resolution. High range resolution can be achieved using pulse compression techniques. The SAR is typically flown on a platform. The platform can be an aircraft, a spacecraft, unmanned aerial vehicle (UAV) such as a drone, or another suitable platform. The target of interest is typically on the ground, and can be a point target or a distributed target. In the present application, the term ground refers to land, sea, and ice. The target can be on land, water, ice, or in the air. The SAR can be a component of a SAR imaging system, the system also including at least one of a data processing and a data distribution component.

In conventional operation of the SAR imaging system, the system is tasked to obtain images of a point target and/or a distributed target. A distributed target can be a region on the ground. In the present application, and in the context of imaging targets on the Earth's surface, the term swath refers to a strip of the Earth's surface imaged by the SAR. One or more image products can be extracted from data collected over a swath.

Data is collected on-board the platform. In the case of a spaceborne SAR, the data is collected on-board the spacecraft, and either processed on-board the spacecraft and downlinked to the ground, or downlinked and processed on the ground to generate the images. The images are distributed to the user, typically via a network.

A SAR imaging system can be operated in one or more imaging modes (also referred to in the present application as acquisition modes). For the purposes of the present application, an imaging mode is defined as a combination of antenna beams and other operating parameters of the SAR imaging system. Imaging modes of the SAR imaging system may include Stripmap, Spotlight, and ScanSAR modes. Stripmap mode typically assumes a fixed pointing direction of the antenna beam at least approximately broadside to the track of the platform. A SAR image in the form of a strip map can be formed, where the width of the image (also referred to in the present application as the swath width) is determined at least in part by the cross-track extent of the antenna beam, and where the strip follows the length contour of the track of the platform.

In Spotlight mode, the radar can be steered to keep a target in the beam for a longer time, and to increase the resolution of the resulting image. Steering can include electronic beam steering. There can be a trade-off between resolution and the size of the swath. Spatial coverage is typically lower in Spotlight mode than Stripmap mode.

In ScanSAR mode, a SAR imaging system can acquire data over a wider swath by illuminating several sub-swaths using different beams of the radar (for example, beams at different off-nadir angles) and combining them to form a single image. There can be a trade-off between resolution and the size of the swath. Spatial coverage is typically higher in ScanSAR mode than Stripmap mode.

### BRIEF SUMMARY

A method of determining feasible swaths of a synthetic aperture radar (SAR) may be summarized as including determining a first plurality of swaths that are transmit-feasible and nadir-feasible, determining a second plurality of swaths of the first plurality of swaths that satisfy at least one hard constraint, the at least one hard constraint being an image quality constraint or a system constraint, and generating a graph of the second plurality of swaths.

In some implementations, generating a graph of the second plurality of swaths includes generating a directed graph of the second plurality of swaths. In some implementations, generating a directed graph of the second plurality of swaths includes assigning each feasible swath of the second plurality of swaths to a node in a directed graph, defining one or more constraints, and adding a directed edge in the directed graph when a pair of swaths of the second plurality of swaths satisfy the one or more constraints.

In some implementations, the method further includes assigning a weight to the directed edge in the directed graph.

In some implementations, adding a directed edge in the directed graph when a pair of swaths of the second plurality of swaths satisfy the one or more constraints includes adding a directed edge in the directed graph when a pair of swaths of the second plurality of swaths satisfy one or more soft constraints.

In some implementations, adding a directed edge in the directed graph when a pair of swaths of the second plurality of swaths satisfy one or more soft constraints includes computing a value of a variable that is penalized in an objective function by a penalty if a condition on the variable is not satisfied, the penalty based on an extent to which the condition is not satisfied.

In some implementations, adding a directed edge in the directed graph when a pair of swaths of the second plurality of swaths satisfy one or more soft constraints includes adding a directed edge in the directed graph when a pair of swaths of the second plurality of swaths satisfy a degree of overlap between the pair of swaths of the second plurality of swaths, the degree of overlap which is expressible as a percentage of a width of one swath of the pair of swaths of the second plurality of swaths.

In some implementations, generating a directed graph of the second plurality of swaths includes assigning each feasible swath of the second plurality of swaths to a node in a directed graph, and the method further includes determining a shortest path between each pair of nodes in the directed graph. In some implementations, determining a shortest path between each pair of nodes in the directed graph includes constructing an adjacency matrix in which each element of the adjacency matrix indicates the shortest path between a pair of nodes expressed as a number of edges traversed to connect a first node of the pair of nodes with a second node of the pair of nodes. In some implementations, constructing an adjacency matrix in which each element of the adjacency matrix indicates the shortest path between the pair of nodes expressed as a number of edges traversed to connect a first node of the pair of nodes with a second node of the pair of nodes includes assigning the first node of the pair of nodes to a first feasible swath, assigning the second node of the pair of nodes to a second feasible swath, the first feasible swath meeting a first constraint on the nearest ground range of the first feasible swath, and the second feasible swath meeting a second constraint on the farthest ground range of the second feasible swath.

In some implementations, determining a shortest path between each pair of nodes in the directed graph includes determining a preferred shortest feasible path from multiple shortest feasible paths. In some implementations, determining a preferred shortest feasible path from multiple shortest feasible paths includes defining a cost function and determining a shortest feasible path of the multiple shortest feasible paths that minimizes or at least reduces a value of the cost function relative to other of the multiple shortest feasible paths. In some implementations, defining a cost function includes defining a cost function that includes one or more image quality metrics.

In any of the above described implementations, determining feasible swaths of a SAR may include determining feasible swaths of a SAR operating in a ScanSAR mode.

In various of the above described implementations, determining feasible swaths of a SAR may include determining feasible swaths of a spaceborne SAR.

In any of the above described implementations, the method may further include configuring the SAR to operate based at least in part on the generated graph of the second plurality of swaths. In some implementations, the method further includes operating the configured SAR to obtain SAR images.

A synthetic aperture radar (SAR) system operative to determine feasible swaths of a SAR may be summarized as including at least one nontransitory processor-readable storage medium that stores at least one of instructions or data, and at least one processor communicatively coupled to the at least one nontransitory processor-readable storage medium, in operation, the at least one processor performs the method of any of the above described implementations.

A nontransitory processor-readable storage medium that stores at least one of instructions or data that, when executed by at least one processor, may be summarized as causing the at least one processor to perform the method of various of the above described implementations.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram illustrating the illumination geometry of an example implementation of a SAR imaging system in accordance with the present systems, devices, methods, and articles.

FIG. 2 is a schematic diagram illustrating the illumination geometry of another example implementation of a SAR imaging system in accordance with the present systems, devices, methods, and articles.

FIG. 3 is a block diagram illustrating an example implementation of a SAR imaging system in accordance with the present systems, devices, methods, and articles.

FIG. 4 is a flow chart illustrating a method of determining operational parameters of a SAR imaging system in accordance with the present systems, devices, methods, and articles.

FIGS. 5A to 5H are charts illustrating example feasible swaths of a SAR imaging system (for example, the SAR imaging system of one of FIGS. 1, 2, and 3) in accordance with the present systems, devices, methods, and articles.

FIG. 6A is a chart that illustrates example swaths of a SAR imaging system (for example, the SAR imaging system of one of FIGS. 1, 2, and 3) in accordance with the present systems, devices, methods, and articles.

FIG. 6B is a directed graph representing the example feasible swaths of FIG. 6A.

FIG. 7 is an adjacency matrix corresponding to the directed graph of FIG. 6B.

FIG. 8 is an adjacency matrix that indicates the shortest path expressed as a number of edges traversed to connect a node for one swath with a node for another swath.

FIG. 9A is an adjacency matrix that indicates the shortest path expressed as a number of edges traversed to connect a source node to a target node.

FIG. 9B is a pair of directed graphs, one for each of the two feasible paths of FIG. 9A.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure and headings provided herein are for convenience only and do not interpret the scope or meaning of the embodiments.

The technology described in the present application includes a method for determining operational parameters of a SAR imaging system, for example a spaceborne SAR with ScanSAR beams. In particular, the technology includes a method for determining feasible imaging swaths of a SAR imaging system. The technology can be used to determine feasible swaths of a SAR imaging system operating with ScanSAR, Strip Map, and/or Spotlight beams. The technology can be used to determine feasible SAR swaths for single-band, multi-band, single-aperture, and/or multi-aperture SAR imaging systems.

One conventional approach to finding operational parameters for a SAR image product (e.g. a ScanSAR image product) is a) to start with a set of initial operational parameters (for example, based on experience), and b) to adjust the operational parameters until a set of operational parameters is found that adequately satisfies a set of image quality requirements. Shortcomings of a conventional approach can include the following: a) that the approach can be time-consuming and inefficient, b) a need for subject matter expertise, c) a failure to handle multi-band SAR where there are interdependent feasible swaths at multiple SAR frequencies, d) a low probability of finding an optimal (or even preferred) solution, and e) a lack of robustness with respect to changes in the SAR system.

The technology described in the present application includes the use of graph theory to determine operational parameters of a SAR imaging system including a number of beams, a respective PRF of each beam, and a respective swath width of each beam. Operational parameters can be determined subject to a number of constraints on various parameters of the SAR system and on various SAR image quality metrics. The technology described in the present application can include iteration. The technology described in the present application can be automated.

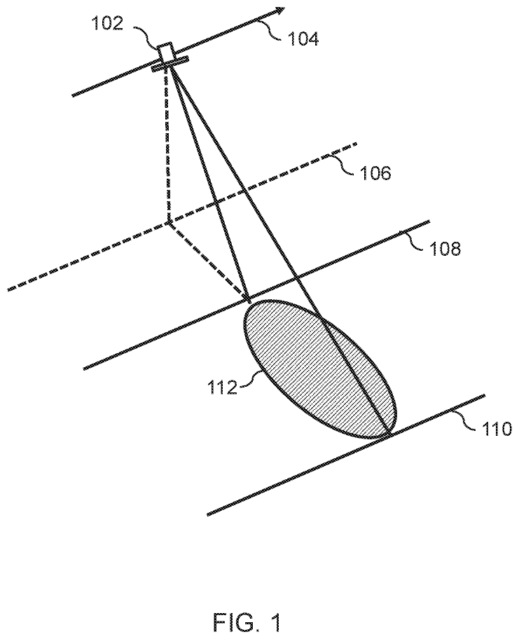

FIG. 1 is a schematic diagram illustrating the illumination geometry of an example implementation of a SAR imaging system in accordance with the present systems, devices, methods, and articles. The SAR imaging system of FIG. 1 comprises a SAR platform 102 which, in the illustrated implementation of FIG. 1 is a spaceborne platform. Spaceborne platform 102 can be, for example, a satellite, a spacecraft, or a space station. In some implementations, SAR platform 102 is an aircraft or an unmanned aircraft such as a drone, for example.

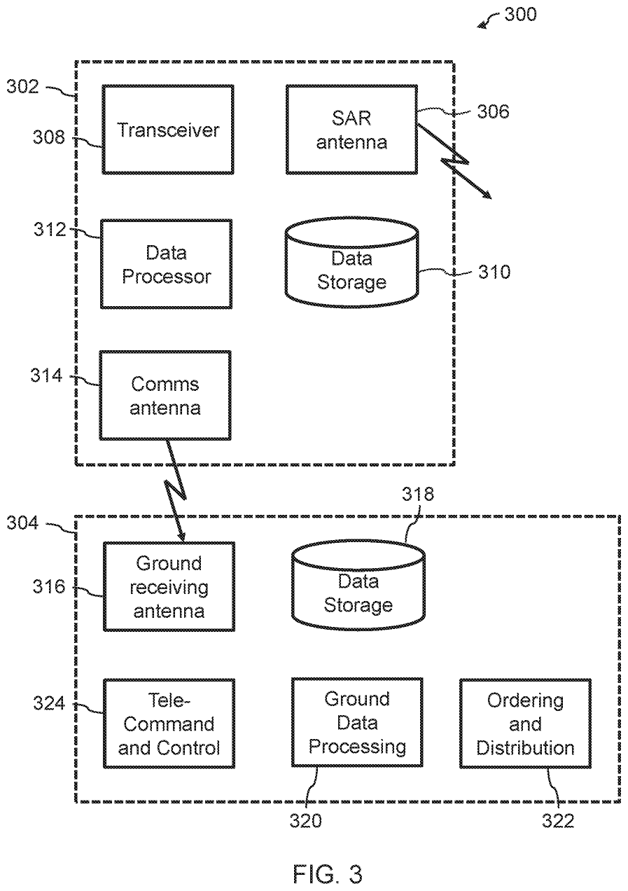

SAR platform 102 comprises a SAR (not called out in FIG. 1). Elements of the SAR are described below in the present application with reference to FIG. 3. In some implementations, SAR platform 102 communicates with a ground receiving station (also referred to in the present application as a ground terminal, and not shown in FIG. 1).

SAR platform 102 flies along trajectory 104. Dashed line 106 indicates the ground track of SAR platform 102. Line 108 and line 110 indicate the near-side and the far-side of a swath, respectively. Shaded region 112 represents a main lobe of a SAR antenna beam pattern on the ground.

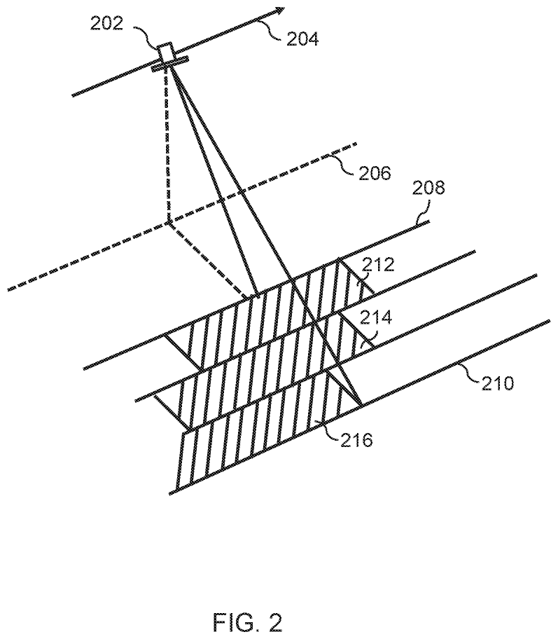

FIG. 2 is a schematic diagram illustrating the illumination geometry of another example implementation of a SAR imaging system in accordance with the present systems, devices, methods, and articles.

The SAR imaging system of FIG. 2 comprises a SAR platform 202 which, in the illustrated implementation of FIG. 2 is a spaceborne platform. Spaceborne platform 202 can be, for example, a satellite, a spacecraft, or a space station. In some implementations, SAR platform 202 is an aircraft or an unmanned aircraft such as a drone, for example.

SAR platform 202 comprises a SAR (not called out in FIG. 2). Elements of the SAR are described below in the present application with reference to FIG. 3. In some implementations, SAR platform 202 communicates with a ground receiving station (also referred to in the present application as a ground terminal, and not shown in FIG. 2).

SAR platform 202 flies along trajectory 204. Dashed line 206 indicates the ground track of SAR platform 202. Line 208 and line 210 indicate the near-side and the far-side of a swath, respectively.

FIG. 2 illustrates the SAR of SAR platform 202 in a ScanSAR imaging mode in which data are acquired over a wider swath by illuminating several sub-swaths using different beams of the radar (for example, beams at different off-nadir angles) and combining them to form a single image. Shaded regions 212, 214, and 216 are sub-swaths.

FIG. 3 is a block diagram illustrating an example implementation of a SAR imaging system 300 in accordance with the present systems, devices, methods, and articles.

SAR imaging system 300 comprises synthetic aperture radar (SAR) 302 and ground system 304. SAR 302 can be mounted on an airborne or a spaceborne SAR platform such as an aircraft, drone, satellite or space station, as illustrated in FIGS. 1 and 2.

SAR 302 comprises one or more antenna 306, transceiver 308, nontransitory SAR data storage media 310, and SAR data processor 312 (e.g., hardware circuitry). Antenna 306 is bi-directionally communicatively coupled to transceiver 308. Transceiver 308 is bi-directionally communicatively coupled to data storage 310 and data processor 312. Data storage 314 is bi-directionally communicatively coupled to data processor 312.

Data storage 310 can take the form of one or more computer- or processor-readable memories or storage media, for instance volatile memory (e.g., RAM), nonvolatile memory (e.g., ROM, FLASH, EEPROM), or spinning media (e.g., magnetic disk, optical disk) with associated readers and/or writers.

Data processor 312 can comprise one or more data processing elements such as a modulator, an encoder, a device to perform encryption, and the like. Data processor 312 can also comprise one or more control elements such as a controller to determine when to switch modes of operation, to command the SAR to switch operation and to synchronize operations in each mode.

Data processor 312 can take the form of one or more circuits or circuitry or hardware, for instance one or more microprocessors (single or multicore), central processor units (CPUs), digital signal processors (DSPs), graphic processing units (GPUs), application specific integrated circuits (ASICs), programmable gate arrays (PGAs), or programmable logic units (PLUs).

Ground system 304 comprises antenna 316, data storage 318, ground data processing subsystem 320, ordering and distribution subsystem 322, and telecommand and control subsystem 324.

Data storage 318 can take the form of one or more computer- or processor-readable memories or storage media, for instance volatile memory (e.g., RAM), nonvolatile memory (e.g., ROM, FLASH, EEPROM), or spinning media (e.g., magnetic disk, optical disk) with associated readers and/or writers. Ground data processing subsystem 320 can take the form of one or more circuits or circuitry or hardware, for instance one or more microprocessors (single or multicore), central processor units (CPUs), digital signal processors (DSPs), graphic processing units (GPUs), application specific integrated circuits (ASICs), programmable gate arrays (PGAs), or programmable logic units (PLUs).

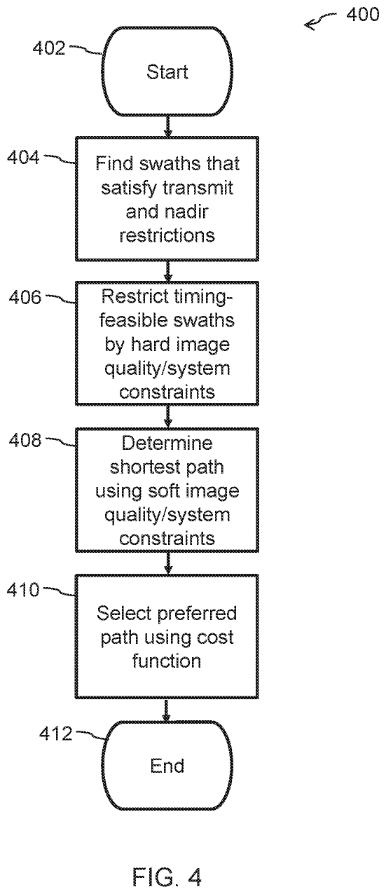

FIG. 4 is a flow chart illustrating a method 400 of determining operational parameters of a SAR imaging system in accordance with the present systems, devices, methods, and articles. Method 400 includes acts 402 to 412.

Some acts of method 400 may be performed in an order other than described in the present application and illustrated in FIG. 4, or may be performed in parallel with one or more other acts, or may be combined with one or more other acts. To the extent that some acts of method 400 rely on the results of other acts, acts of method 400 may need to be performed in a particular sequence.

It should be appreciated that, in various implementations of method 400, not all of the acts illustrated in FIG. 4 are performed, that other acts (not shown in FIG. 4) are performed, and/or that other acts (not shown in FIG. 4) are substituted for one or more of the illustrated acts of FIG. 4.

Method 400 begins at 402, for example in response to a request from an operator input or in response to a command from another system.

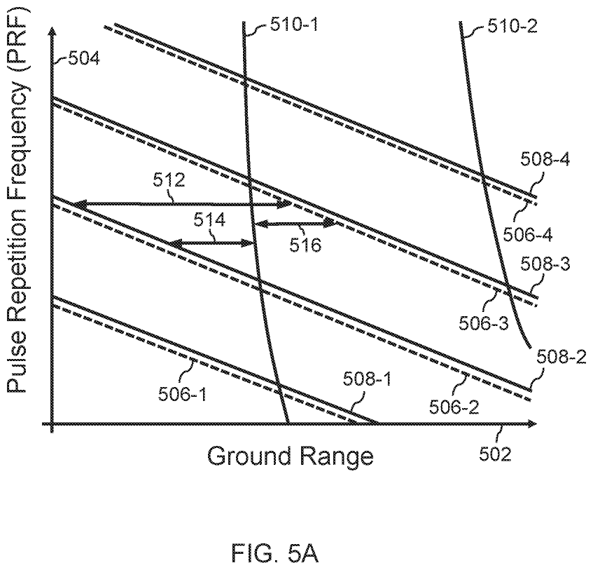

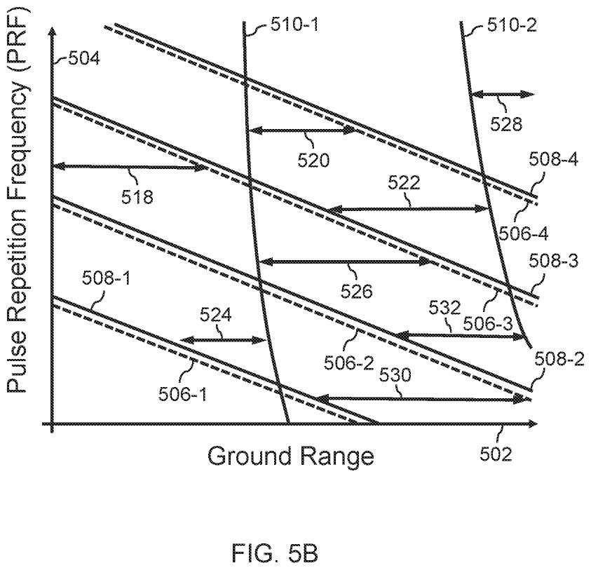

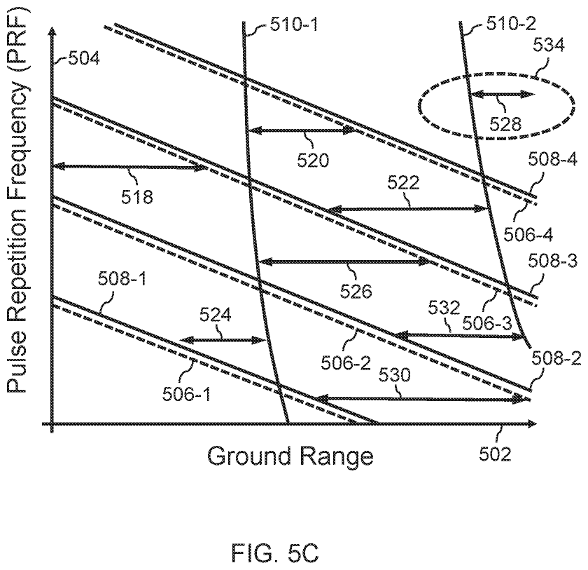

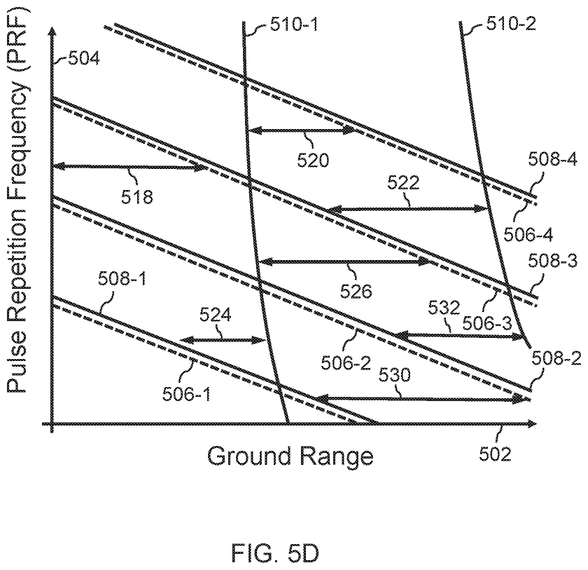

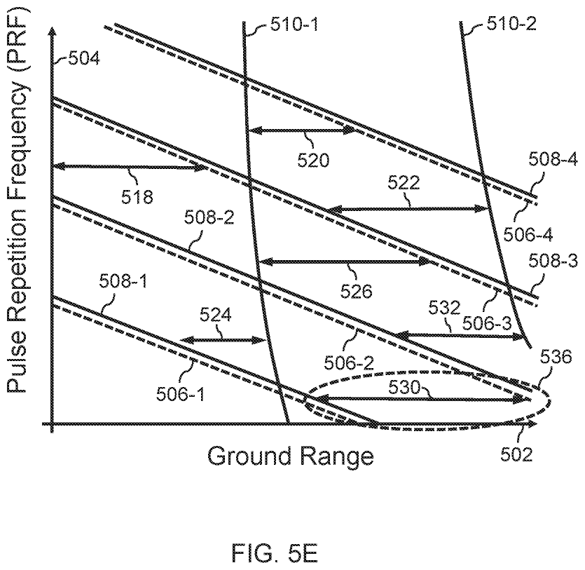

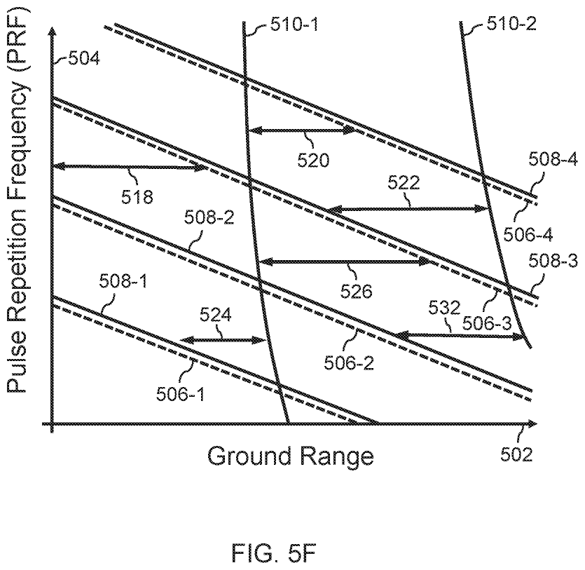

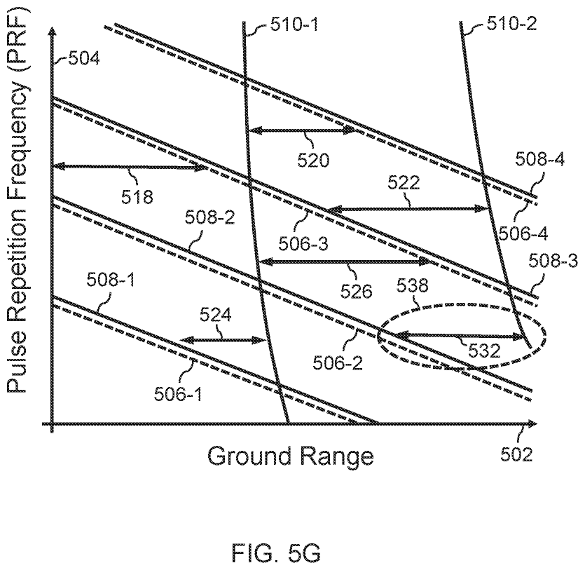

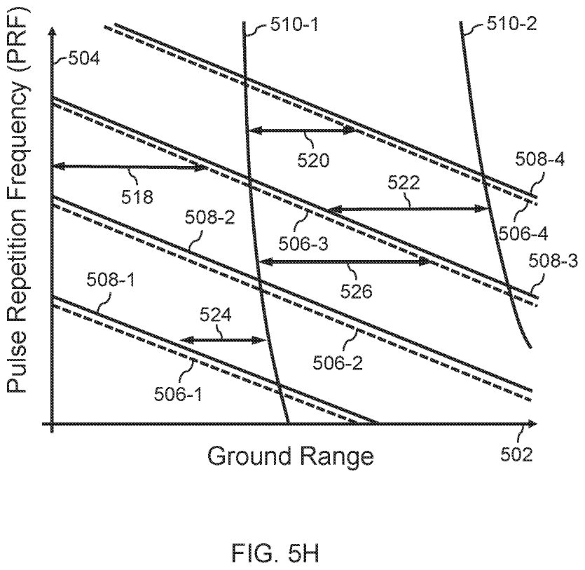

Act 404 of method 400 finds swaths that satisfy transmit and nadir restrictions. Act 404 is described in more detail below with reference to FIG. 5A.

Act 406 restricts timing-feasible swaths by one or more hard image quality constraints and/or by one or more hard system constraints. Act 404 is described in more detail below with reference to FIGS. 5B to 5H.

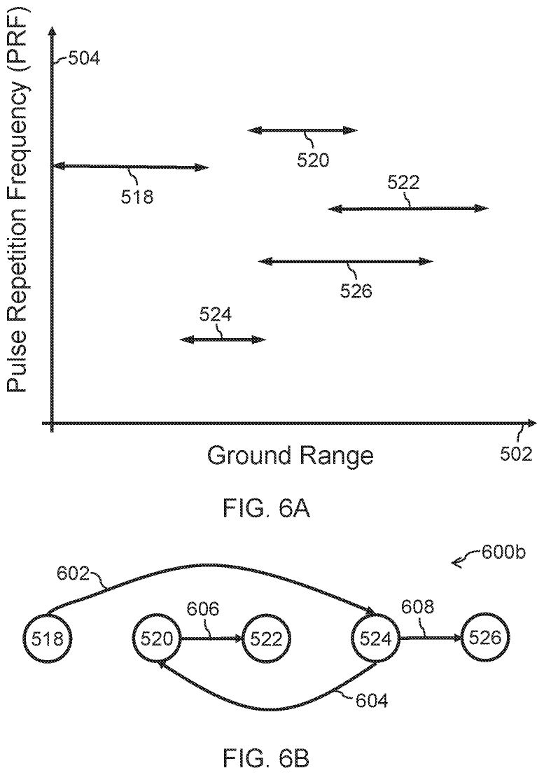

Act 408 determines a shortest path using one or more soft image quality constraints and/or one or more soft system constraints. Act 408 is described in more detail below with reference to FIGS. 6A, 6B, 7, and 8.

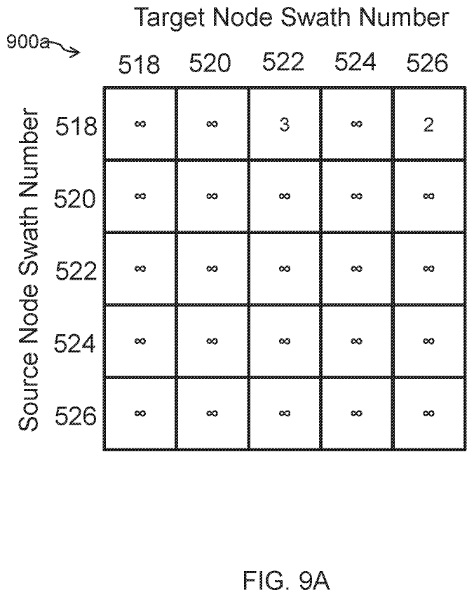

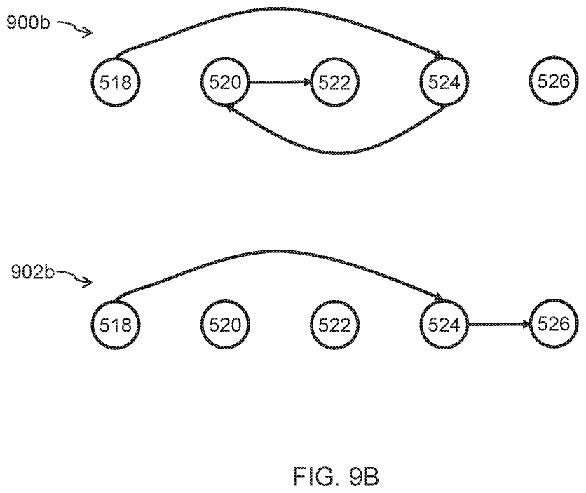

Act 410 selects a preferred path using a cost function. Act 410 is described in more detail below with reference to FIGS. 9A and 9B.

Method 400 terminates at 412. When method 400 terminates, it may perform at least one of the following, for example: a) pass control to another method (not shown in FIG. 4), b) return data to an operator, c) send a command to another system, or d) configure a SAR imaging system to operate based at least in part on the preferred path to obtain SAR images.

FIGS. 5A to 5H are charts illustrating example feasible swaths of a SAR imaging system (for example, the SAR imaging system of one of FIGS. 1, 2, and 3) in accordance with the present systems, devices, methods, and articles. FIG. 5A is a plot of ground range along axis 502 and pulse repetition frequency (PRF) along axis 504.

Dashed lines 506-1, 506-2, 506-3, and 506-4 (collectively referred to as dashed lines 506) indicate the start of transmission of a pulse by the SAR imaging system. Solid lines 508-1, 508-2, 508-3, and 508-4 (collectively referred to as solid lines 508) indicate the end of transmission of a pulse by the SAR imaging system.

The width of a line drawn parallel to axis 502 and extending from one of solid lines 508 to a first intersection with one of dashed lines 506 corresponds (where ground range is mapped to time) to a pulse repetition interval (PRI) less the time of transmission of a pulse. The time of transmission of a pulse is also referred to in the present application as a pulse width or a pulse duration. During the time corresponding to the width of a line drawn parallel to axis 502 and extending from one of solid lines 508 to a first intersection with one of dashed lines 506, the SAR imaging system is not transmitting a pulse.

The width of a line drawn parallel to axis 502 and extending from one of dashed lines 506 to a first intersection with one of solid lines 508 corresponds (where ground range is mapped to time) to a pulse length plus an additional time referred to in the present application as a pulse guard. During this time, the SAR imaging system is transmitting a pulse. Typically, the pulse length is much less than the PRI.

Solid lines 510-1 and 510-2 (collectively referred to in the present application as solid lines 510) indicate the timing of a radar return from nadir (e.g. ground track 106 of FIG. 1) for a transmitted pulse.

The present application refers to a swath as “transmit-feasible” if the SAR antenna is not required to transmit a pulse and receive a radar return from a previous pulse at the same time. A swath is transmit-feasible if the swath (defined by an interval in ground range) lies entirely between a solid line of solid lines 508 and the succeeding dashed line of dashed lines 506. Swath 512 is an example of a transmit-feasible swath. Swath 512 lies entirely between solid line 508-2 and dashed line 506-3.

The present application refers to a swath as “nadir-feasible” if SAR antenna is not receiving a radar return from a position in the swath for a previous pulse at the same time as it is receiving a radar return from the nadir for another previous pulse. A swath is nadir-feasible if the swath (defined by an interval in ground range) does not intersect one of solid lines 510. Example swaths 514 and 516 are examples of nadir-feasible swaths. Example swaths 514 and 516 are examples of swaths that are both transmit-feasible and nadir-feasible.

Elements in FIGS. 5B to 5H labeled with the same numbers as in FIG. 5A are similar, or even identical, to those described with reference to FIG. 5A.

FIG. 5B is a chart that illustrates example swaths of a SAR imaging system (for example, the SAR imaging system of one of FIGS. 1, 2, and 3) in accordance with the present systems, devices, methods, and articles. FIG. 5B is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A.

Swaths 518, 520, 522, 524, 526, 528, 530, and 532 are examples of swaths that are both transmit-feasible and nadir-feasible. Each of swaths 518, 520, 522, 524, 526, 528, 530, and 532 has a respective ground interval (along axis 502 of FIG. 5B) defined by a respective near-range and a respective far-range, and operates at a respective PRF (indicated by where each swath would, if extrapolated, intersect axis 504).

FIG. 5C is a chart that illustrates example swaths of a SAR imaging system (for example, the SAR imaging system of one of FIGS. 1, 2, and 3) in accordance with the present systems, devices, methods, and articles. FIG. 5C is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A. Swaths 518, 520, 522, 524, 526, 528, 530, and 532 are examples of swaths that are both transmit-feasible and nadir-feasible.

Range ambiguities in SAR can occur when radar returns from preceding and succeeding pulse are received at the SAR antenna at the same time. Range ambiguities can affect SAR image quality. Range ambiguities can be measured, for example, by a Range Ambiguity to Signal Ratio (RASR). It can be desirable for the worst-case range ambiguities of a SAR to be kept below a predetermined threshold.

Region 534 includes one or more swaths that fail to meet an image quality constraint imposed on worst-case range ambiguities. In an example scenario, the image quality constraint imposed on worst-case range ambiguities is −19 dB. In the example scenario, a swath containing a range ambiguity that exceeds −19 dB fails to meet the image quality constraint imposed on worst-case range ambiguities, and is eliminated from further consideration as a feasible swath of the SAR imaging system at least in its present mode of operation.

Swath 528 lies at least partially within region 534 and is eliminated from further consideration.

FIG. 5D is a chart that illustrates example swaths of a SAR imaging system (for example, the SAR imaging system of one of FIGS. 1, 2, and 3) in accordance with the present systems, devices, methods, and articles. FIG. 5D is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A. Swaths 518, 520, 522, 524, 526, 530, and 532 are examples of swaths that a) are transmit-feasible and nadir-feasible, and b) meet an image quality constraint imposed on worst-case range ambiguities.

FIG. 5E is a chart that illustrates example swaths of a SAR imaging system (for example, the SAR imaging system of one of FIGS. 1, 2, and 3) in accordance with the present systems, devices, methods, and articles. FIG. 5E is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A. Swaths 518, 520, 522, 524, 526, 530, and 532 are examples of swaths that a) are transmit-feasible and nadir-feasible, and b) meet an image quality constraint imposed on worst-case range ambiguities.

Azimuth ambiguities in SAR can result from finite sampling of the azimuth frequency spectrum at the pulse repetition frequency (PRF). Azimuth ambiguities can affect SAR image quality. Azimuth ambiguities can be measured, for example, by an Azimuth Ambiguity to Signal Ratio (AASR). It can be desirable for the worst-case azimuth ambiguities of a SAR to be kept below a predetermined threshold.

Region 536 includes one or more swaths that fail to meet an image quality constraint imposed on worst-case azimuth ambiguities. In an example scenario, the image quality constraint imposed on worst-case azimuth ambiguities is −19 dB. In the example scenario, a swath containing an azimuth ambiguity that exceeds −19 dB fails to meet the image quality constraint imposed on worst-case azimuth ambiguities, and is eliminated from further consideration as a feasible swath of the SAR imaging system in at least its present mode of operation.

Swath 530 lies at least partially within region 536 and is eliminated from further consideration.

FIG. 5F is a chart that illustrates example swaths of a SAR imaging system (for example, the SAR imaging system of one of FIGS. 1, 2, and 3) in accordance with the present systems, devices, methods, and articles. FIG. 5F is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A. Swaths 518, 520, 522, 524, 526, and 532 are examples of swaths that a) are transmit-feasible and nadir-feasible, b) meet an image quality constraint imposed on worst-case range ambiguities, and c) meet an image quality constraint imposed on worst-case azimuth ambiguities.

FIG. 5G is a chart that illustrates example swaths of a SAR imaging system (for example, the SAR imaging system of one of FIGS. 1, 2, and 3) in accordance with the present systems, devices, methods, and articles. FIG. 5G is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A. Swaths 518, 520, 522, 524, 526, and 532 are examples of swaths that a) are transmit-feasible and nadir-feasible, b) meet an image quality constraint imposed on worst-case range ambiguities, and c) meet an image quality constraint imposed on worst-case azimuth ambiguities.

Noise Equivalent Sigma Zero (NESZ) describes a magnitude of system noise in terms of an equivalent average power in the image domain, and can be a measure of sensitivity of a SAR. System noise can affect SAR image quality. It can be desirable for the NESZ of a SAR to be kept below a predetermined threshold.

Region 538 includes one or more swaths that fail to meet an image quality constraint imposed on Noise Equivalent Sigma Zero (NESZ). In an example scenario, the image quality constraint imposed on NESZ is −19 dB. In the example scenario, a swath containing an NESZ that exceeds −19 dB fails to meet the image quality constraint imposed on NESZ, and is eliminated from further consideration as a feasible operational mode of the SAR imaging system.

Swath 532 lies at least partially within region 538 and is eliminated from further consideration.

FIG. 5H is a chart that illustrates example swaths of a SAR imaging system (for example, the SAR imaging system of one of FIGS. 1, 2, and 3) in accordance with the present systems, devices, methods, and articles. FIG. 5H is a plot of ground range along axis 502 and pulse repetition frequency (PRF) along axis 504. Dashed lines 506 and solid lines 508 demarcate pulse repetition intervals and pulse lengths as described above in reference to FIG. 5A. Solid lines 510 indicate nadir returns as described above in reference to FIG. 5A. Swaths 518, 520, 522, 524, and 526, are examples of swaths that a) are transmit-feasible and nadir-feasible, b) meet an image quality constraint imposed on worst-case range ambiguities, c) meet an image quality constraint imposed on worst-case azimuth ambiguities and d) meet an image quality constraint imposed on NESZ.

Other suitable image quality metrics can be used as constraints in place of, or in addition to, the image quality metrics described above (range ambiguities, azimuth ambiguities, and NESZ).

FIG. 6A is a chart that illustrates example swaths of a SAR imaging system (for example, the SAR imaging system of one of FIGS. 1, 2, and 3) in accordance with the present systems, devices, methods, and articles. As described with reference to FIG. 5H, swaths 518, 520, 522, 524, and 526, are examples of swaths that a) are transmit-feasible and nadir-feasible, b) meet an image quality constraint imposed on worst-case range ambiguities, c) meet an image quality constraint imposed on worst-case azimuth ambiguities and d) meet an image quality constraint imposed on NESZ.

A graph is defined in the present application as a set of vertices (also referred to in the present application as nodes) with related pairs of vertices, each related pair referred to in the present application as an edge (also referred to in the present application as a link, an arc, or a line). Graphs are a subject of study in a topic of discrete mathematics referred to in the present application as graph theory.

An undirected graph is defined in the present application as a graph in which edges of the graph have no orientation. A directed graph is defined in the present application as a graph in which edges of the graph have orientations. A directed graph can be written as an ordered pair G=(V, E) where V is a set of vertices, and E is a set of ordered pairs of vertices.

FIG. 6B is a directed graph 600b representing example feasible swaths 518, 520, 522, 524, and 526 of FIG. 6A. Directed graph 600b can be generated by a) first assigning each feasible swath of FIG. 6A to a node in a directed graph, for example swath 518 of FIG. 6A is assigned to node 518 in FIG. 6B, swath 520 of FIG. 6A is assigned to node 520 of FIG. 6B, and then b) adding a directed edge when a pair of swaths satisfy one or more constraints.

Constraints can be “soft” constraints. In the present application, a soft constraint is one that has some variable values that are penalized in an objective function if the conditions on the variables are not satisfied, the penalty based on the extent to which the conditions are not satisfied. This is in contrast to “hard” constraints, which set conditions for variables that are required to be satisfied.

In an example implementation, a constraint can be placed on the degree of overlap between a pair of swaths, referred to herein as “swath overlap,” expressed as a percentage. The constraint can be a hard constraint or a soft constraint. For example, the constraint can be that the degree of overlap between the pair of swaths lies between 5% (or other lower threshold) and 50% (or other upper threshold) of the swath width of one of the pair of swaths. In this example, if the degree of overlap between the pair of swaths is greater than 5% and less than 50% of the swath width of one of the pair of swaths, a directed edge corresponding to the pair of swaths is added to the directed graph.

Directed graph 600b includes four directed edges 602, 604, 606, and 608. Swaths 518 and 524 have between 5% and 50% overlap. Likewise, swaths 524 and 520, swaths 520 and 522, and swaths 524 and 526 have between 5% and 50% overlap.

Swaths 518 and 520 have no overlap and consequently no edge between corresponding nodes in directed graph 600b. Likewise, swaths 522 and 524 have no overlap, and consequently no edge between corresponding nodes in directed graph 600b.

Both of swaths 520 and 522 have greater than 50% overlap with swath 526, and consequently no edge with corresponding nodes in directed graph 600b.

In one approach, the constraint is a hard constraint, and no direct edge is formed unless the constraint is met (i.e., unless the swath overlap is between 5% and 50%). In another approach, the constraint is a soft constraint, and a directed edge is weighted (or penalized) based at least in part on the swath overlap.

The direction of each edge is determined by the relative positioning of each swath in ground range. The direction is defined in the present example to be “from” one swath at a nearer ground range “to” another swath at a farther ground range. For example, swath 518 is at a closer ground range than swath 524, and so the direction of edge 602 is “from” swath 518 “to” swath 524. The choice of convention for the direction of an edge in directed graph 600b is driven by a desire, in this example implementation, to find overlapping swaths in a sequence that starts with a feasible swath at the closest ground range, and has each successive overlapping swath at a farther ground range than the previous one.

Directed graph 600b of FIG. 6B can be represented by an adjacency matrix. In the present application (and as typically found in graph theory and computer science), an adjacency matrix is a square matrix used to represent a finite graph. Elements of the adjacency matrix indicate whether pairs of vertices are adjacent or not in the graph using a “0” to indicate a pair of vertices is not adjacent, and a “1” to indicate a pair of vertices is adjacent. In the present application, two vertices V₁ and V₂ in a directed graph are defined to be adjacent if there is an edge from vertex V₁ to vertex V₂.

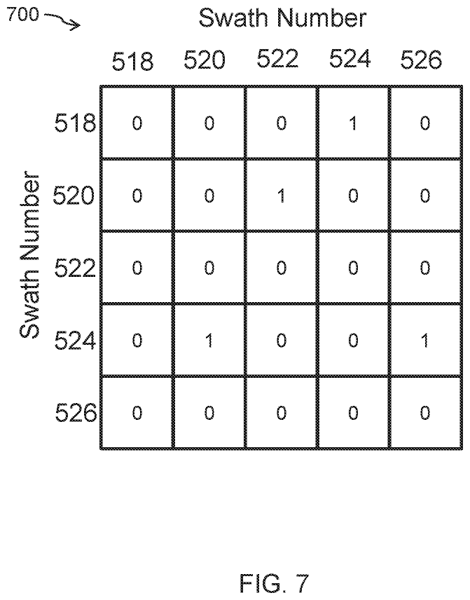

FIG. 7 is an adjacency matrix 700 corresponding to directed graph 600b of FIG. 6B. Adjacency matrix 700 is asymmetric because directed graph 600b is a directed graph. There is a “1” at location (518, 524) because there is a directed edge (i.e., edge 602) “from” node 518 “to” node 524 in directed graph 600b, and no corresponding “1” at location (524, 518).

FIGS. 6B and 7 show a directed graph and adjacency matrix for an example soft constraint on swath overlap. Other suitable soft constraints can be used to generate additional directed graphs and adjacency matrices. Soft constraints can be selected to cause the SAR to be operable to generate a SAR image product that meets desired image quality requirements.

Feasible swaths described above can be associated with a set of operational parameters and image quality measurements, for example, including, but not limited to, PRF, pulse length, near swath ground range, far swath ground range, worst range ambiguity value, average or worst azimuth ambiguity value, worst NESZ value, roll angle of the SAR platform, steering angle of a SAR beam, azimuth resolution, range resolution, and minimum detectable target dimensions. Each constraint, or combination of constraints, can define a directed graph and a corresponding adjacency matrix.

In some implementations, a constraint (e.g. NESZ) can be used to ensure that all feasible swaths have a similar, or at least consistent, image quality metric across the entire SAR image product. One approach is to form an adjacency matrix that represents pairwise comparisons of an image quality metric (e.g. NESZ) between swaths. If a pair of swaths have similar metrics (e.g. within a predetermined threshold), then the corresponding entry in the adjacency matrix is set to “1”. In this case, the adjacency matrix will be symmetric and correspond to an undirected graph.

In some implementations, edges of an adjacency matrix are unweighted or equally weighted. In other implementations, edges of the adjacency matrix are weighted. Weighting edges can provide a quantitative ranking of edges.

A consolidated adjacency matrix can be constructed from an intersection of multiple constituent adjacency matrices. The consolidated adjacency matrix has a “1” at any location (i.e. row and column) where there is a “1” at the same location in all of the constituent adjacency matrices. The consolidated adjacency matrix has a “0” at any location (i.e. row and column) where there is a “0” at the same location in any one of the constituent adjacency matrices. The consolidated adjacency matrix preserves the orientation of edges.

In some scenarios, the number of edges in the consolidated adjacency matrix is the same as the number of edges in one of the constituent adjacency matrices. In other scenarios, the number of edges in the consolidated adjacency matrix is less than the number of edges in one of the constituent adjacency matrices. In yet other scenarios, the number of edges in the consolidated adjacency matrix is zero. In some implementations, at least some of the method described above can be iterated, and at least one of the soft constraints relaxed.

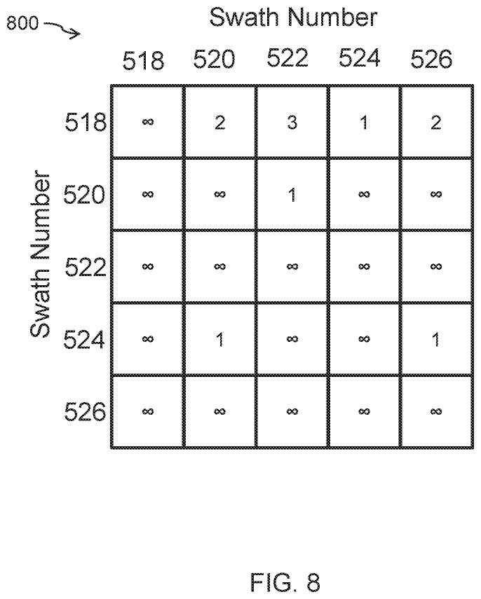

FIG. 8 is an adjacency matrix 800 that indicates the shortest path expressed as a number of edges traversed to connect a node for one swath with a node for another swath. Adjacency matrix 800 can be constructed by determining the shortest path between each pair of nodes in the corresponding directed graph. An infinity symbol “w” is used to indicate there is no path between a pair of swaths.

In the example illustrated in FIG. 8, a path from swath 518 to swath 520 traverses two edges. A path from swath 518 to swath 522 traverses three edges, and so on.

Some implementations include a constraint on minimum ground range and maximum ground range. A node corresponding to a swath that meets the constraint on minimum ground range is referred to in the present application as a source node. A node corresponding to a swath that meets the constraint on maximum ground range is referred to in the present application as a target node. The shortest path between pairs of nodes in the directed graph can be determined for pairs of nodes that include a source node and a target node.

FIG. 9A is an adjacency matrix 900a that indicates the shortest path expressed as a number of edges traversed to connect a source node to a target node. In this illustrated example, node 518 meets the constraint on minimum ground range and is therefore a source node, and nodes 522 and 526 meet the constraint on maximum ground range and are therefore target nodes. In the example scenario illustrated in FIG. 9A, there are only two feasible paths.

FIG. 9B is a pair of directed graphs 900b and 902b, one for each of the two feasible paths of FIG. 9A.

In some scenarios, it is desirable to select the shortest path of the available feasible paths of FIG. 9B, i.e., to select swaths 518, 524, and 526 as SAR image product swaths in the present operational mode of the SAR imaging system.

In some implementations, the technology described in the present application includes selecting between multiple shortest feasible paths. One approach is to define a cost function and determine the shortest feasible path that minimizes or at least reduces the cost relative to the other paths. The cost function can include one or more image quality metrics.

The various embodiments and implementations described above can be combined to provide further embodiments and implementations. The various patents, applications and publications described above are incorporated herein by reference, in their entirety. Aspects of the embodiments and implementations can be modified, if necessary, to employ concepts of the various patents, applications and publications to provide yet further embodiments and implementations.

The foregoing detailed description has, for instance, set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

This application claims the benefit of priority to U.S. Provisional Application No. 62/870,917 filed Jul. 5, 2019, the entirety of which is incorporated by reference herein.

What is claimed is:

1. A method of determining feasible swaths of a synthetic aperture radar (SAR), the method comprising:
determining a first plurality of swaths that are transmit-feasible and nadir-feasible;
determining a second plurality of swaths of the first plurality of swaths that satisfy at least one hard constraint, the at least one hard constraint being an image quality constraint or a system constraint; and
generating a graph of the second plurality of swaths.

2. The method of claim 1, wherein generating a graph of the second plurality of swaths includes generating a directed graph of the second plurality of swaths.

3. The method of claim 2, wherein generating a directed graph of the second plurality of swaths includes assigning each feasible swath of the second plurality of swaths to a node in a directed graph, defining one or more constraints, and adding a directed edge in the directed graph when a pair of swaths of the second plurality of swaths satisfy the one or more constraints.

4. The method of claim 3, further comprising assigning a weight to the directed edge in the directed graph.

5. The method of claim 3, wherein adding a directed edge in the directed graph when a pair of swaths of the second plurality of swaths satisfy the one or more constraints includes adding a directed edge in the directed graph when a pair of swaths of the second plurality of swaths satisfy one or more soft constraints.

6. The method of claim 5, wherein adding a directed edge in the directed graph when a pair of swaths of the second plurality of swaths satisfy one or more soft constraints includes computing a value of a variable that is penalized in an objective function by a penalty if a condition on the variable is not satisfied, the penalty based on an extent to which the condition is not satisfied.

7. The method of claim 5, wherein adding a directed edge in the directed graph when a pair of swaths of the second plurality of swaths satisfy one or more soft constraints includes adding a directed edge in the directed graph when a pair of swaths of the second plurality of swaths satisfy a degree of overlap between the pair of swaths of the second plurality of swaths, the degree of overlap which is expressible as a percentage of a width of one swath of the pair of swaths of the second plurality of swaths.

8. The method of claim 2, wherein generating a directed graph of the second plurality of swaths includes assigning each feasible swath of the second plurality of swaths to a node in a directed graph, the method further comprising determining a shortest path between each pair of nodes in the directed graph.

9. The method of claim 8, wherein determining a shortest path between each pair of nodes in the directed graph includes constructing an adjacency matrix in which each element of the adjacency matrix indicates the shortest path between a pair of nodes expressed as a number of edges traversed to connect a first node of the pair of nodes with a second node of the pair of nodes.

10. The method of claim 9, wherein constructing an adjacency matrix in which each element of the adjacency matrix indicates the shortest path between the pair of nodes expressed as a number of edges traversed to connect a first node of the pair of nodes with a second node of the pair of nodes includes assigning the first node of the pair of nodes to a first feasible swath, assigning the second node of the pair of nodes to a second feasible swath, the first feasible swath meeting a first constraint on the nearest ground range of the first feasible swath, and the second feasible swath meeting a second constraint on the farthest ground range of the second feasible swath.

11. The method of claim 8, wherein determining a shortest path between each pair of nodes in the directed graph includes determining a preferred shortest feasible path from multiple shortest feasible paths.

12. The method of claim 11, wherein determining a preferred shortest feasible path from multiple shortest feasible paths includes defining a cost function and determining a shortest feasible path of the multiple shortest feasible paths that minimizes or at least reduces a value of the cost function relative to other of the multiple shortest feasible paths.

13. The method of claim 12, wherein defining a cost function includes defining a cost function that includes one or more image quality metrics.

14. The method of any of claims 1 to 13 wherein determining feasible swaths of a SAR includes determining feasible swaths of a SAR operating in a ScanSAR mode.

15. The method of any of claims 1 to 13 wherein determining feasible swaths of a SAR includes determining feasible swaths of a spaceborne SAR.

16. The method of any of claims 1 to 15, further comprising:
configuring the SAR to operate based at least in part on the generated graph of the second plurality of swaths.

17. The method of claim 16, further comprising:
operating the configured SAR to obtain SAR images.

18. A synthetic aperture radar (SAR) system operative to determine feasible swaths of a SAR, the SAR system comprising:
at least one nontransitory processor-readable storage medium that stores at least one of instructions or data; and
at least one processor communicatively coupled to the at least one nontransitory processor-readable storage medium, in operation, the at least one processor:
performs the method of any of claims 1-17.

19. A nontransitory processor-readable storage medium that stores at least one of instructions or data that, when executed by at least one processor, cause the at least one processor to perform the method of any of claims 1-17.
